(19) United States
(12) Patent Application Publication
(10) Pub. No.: US 2014/0283015 A1
(43) Pub. Date: Sep. 18, 2014

(54) GRAVITY-BASED ACCESS CONTROL

(71) Applicant: LINKEDIN CORPORATION, Mountain View, CA (US)

(72) Inventors: Adrian Ancona Novelo, Sunnyvale, CA (US); Sivakumar Loganathan, San Carlos, CA (US)

(73) Assignee: LinkedIn Corporation, Mountain View, CA (US)

(21) Appl. No.: 13/842,442

(22) Filed: Mar. 15, 2013

(51) Int. Cl. G06F 21/31

(52) U.S. Cl. CPC G06F 21/31
USPC 726/19

(57) ABSTRACT

Apparatus and methods are provided for gravity-based access control. An apparatus may be secured with a gravity-based password that reflects a pattern of manipulation or movement of the apparatus. As the apparatus is moved or reoriented, data produced by a sensor (e.g., an accelerometer, a gyroscope, a position sensor) is assembled to form the password. Elements of the password may identify surfaces of the apparatus as it is flipped or placed in different orientations, or may represent the received sensor data (e.g., acceleration force of gravity, displacement). The sensor data may be multi-dimensional. A target or model password is received and saved, and a user must recreate or re-enter the same pattern in order to unlock the device or otherwise make it available for use.

### FIELD

This invention relates to computer systems and data processing. In particular, apparatus and methods are provided for gravity- and/or acceleration-based methods of securing access to an electronic device.

### BACKGROUND

Most forms of securing access to or use of an electronic device, such as a smart phone or portable computing device, employ a traditional scheme such as a security code or a username/password combination. The security code or the username/password combination may be needed to authenticate oneself, to resume a user session, to unlock the device for use, etc. These traditional security features require a user to manually enter the necessary information as text.

These forms of access control have proven useful and reliable for stationary computer systems and other equipment and devices that are relatively large and that feature full-sized (or at least near full-sized) components for entering the necessary information, such as a keyboard. However, smart phones and hand-held computing devices typically do not feature such components, and are often manipulated by a user who is in motion (e.g., walking, driving), or is distracted, or must operate the device with just one hand, or is otherwise not able to enter the necessary information with precision.

When required to enter a security code, password or username/password combination using small or even miniature input controls (e.g., keys, buttons, icons), a user of a portable electronic device may make frequent errors in its entry. This may cause the user to refrain from employing a security feature (e.g., to avoid having to enter a security code) and therefore leave the device vulnerable to misuse, may cause her to choose a simplistic code that is easily overcome, and/or may make her very annoyed and frustrated.

### SUMMARY

In some embodiments of the invention, apparatus and methods are provided for implementing gravity-based access control. In these embodiments, a gravity-based password is derived from a pattern of movement or motion of the apparatus. The pattern of movement may be captured as a series of data generated by one or more sensors within the apparatus (e.g., accelerometer, gyroscope, position sensor). One pattern is used to generate a target or model password to save. When the device or other software or hardware resource is locked or secured, a user re-enters the password by repeating the target or model pattern of manipulation.

In some embodiments, variance may be built into the saved password data, and/or may be applied to data generated when the user re-enters the password (e.g., to unlock the device). Depending on the type of motion involved in the password, matching a current password entry with the stored password may involve comparing multiple data values, comparing graphs of plotted data values and/or other processing.

In some embodiments of the invention, a surface sequence gravity-based password involves a sequence of sides or surfaces of the device. Entry of the password involves manipulating the device such that the corresponding surface faces downward (or in some other direction) more than any other surface. The stored password may consist of data identifying the sequence of surfaces exposed by the pattern of manipulation.

In some embodiments of the invention, a free-motion gravity-based password involves free-form three-dimensional movement of the device. As the device is moved, one or more sensors output data representing one or more forces acting on the device (e.g., acceleration, gravity) or a condition of the device (e.g., change in orientation). The stored password may consist of the sensor data (possibly after being processed), which may be graphed.

### BRIEF DESCRIPTION OF THE DRAWINGS

FIGS. 1A-B are block diagrams of a device with which a method of gravity-based access control may be implemented, in accordance with some embodiments of the invention.

FIGS. 2A-B are block diagrams of a device with which a method of gravity-based access control may be implemented, demonstrating manipulation of the device, in accordance with some embodiments of the invention.

FIGS. 3A-B are block diagrams of a device compatible with a gravity-based access control scheme, in accordance with some embodiments of the invention.

FIGS. 4A-C are graphs of data associated with a gravity-based method of access control, in accordance with some embodiments of the invention.

FIGS. 5A-B are a flow chart demonstrating a gravity-based method of access control, in accordance with some embodiments of the invention.

FIG. 6 is a diagram of an apparatus for implementing a gravity-based access control scheme, according to some embodiments of the invention.

### DETAILED DESCRIPTION

The following description is presented to enable any person skilled in the art to make and use the invention. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown.

In some embodiments of the invention, apparatus and methods are provided for securing access to or use of a device, via a pattern of physical manipulation of the device. When the device is secured or locked, unlocking it requires physical manipulation of the device in a pattern or manner that matches a saved model or target pattern. If the pattern of physical manipulation of the device sufficiently matches the model pattern, the device will be unlocked or otherwise made available for use.

In embodiments of the invention described herein, a pattern of manipulation or motion of a device may be termed a “password” to reflect its role in securing or allowing access to or use of the device or an associated system. The device may be a smart phone, a portable computer or other equipment that includes a gravity sensor (e.g., an accelerometer) and a processor, and may include other components (e.g., gyroscope, GPS or Global Positioning Satellite receiver, volatile and/or non-volatile data storage) that may or may not be used in creating or entering a password.

Embodiments of the invention are described herein for securing the device itself, but may be readily modified for controlling access to other equipment. In these embodiments, manipulation of the device with the correct pattern unlocks another entity, such as a workstation, server computer, portable computer or other equipment coupled to the device via a wireless or wired connection. Therefore, a correctly entered gravity-based password may unlock the device that was manipulated, another entity coupled to the device, an application executing on the device or other entity, or some component of the device or other entity.

Although passwords implemented in some embodiments of the invention discussed herein are termed “gravity” or “gravity-based” passwords or methods of access control, sensors and forces used to implement the password may measure acceleration, rotation, displacement (i.e., a change in location) and/or other factors in addition to or instead of gravity. Depending on the embodiment of the invention being described, the password or access control method could also, or instead, be characterized as an acceleration-based password, movement-based access control, etc.

The term “gravity-based” should be understood to apply to all forms of access control described herein that use data from one or more device sensors, regardless of the forces for which those sensors produce data—such as gravity, acceleration, rotation or tilt, altitude, depth, other spatial displacement, etc. Similarly, a sensor that produces data used in the creation or entry of a password may be termed a “gravity sensor,” regardless of the type of sensor and type of data it produces.

In embodiments of the invention, physical manipulation of a device causes its gravity sensor to produce data depicting, representing or characterizing the manipulation. Data representing a first pattern of manipulation is stored as a password. When the device is later manipulated in an attempt to replicate the stored password to unlock the device or for some other purpose, data representing the current manipulation is compared to the stored data. If the current data matches the stored data, possibly allowing for some variance or error, the device is unlocked or made available for the desired purpose.

FIG. 1A is a block diagram of a device for implementing gravity-based access control, according to some embodiments of the invention. In these embodiments, device 100 is a smart phone or other portable device having a gravity sensor and a processor.

Device 100 has a front (obverse 102) and back (reverse 112, not visible in FIG. 1A), a top (head 104, not visible in FIG. 1A) and bottom (tail 114), and a right side (right edge 106) and left side (left edge 116, not visible in FIG. 1A). Illustratively, the device may have a display component (e.g., a display screen on obverse 102), input/output ports, image sensor(s), various buttons, keys and/or other controls arrayed on any or all surfaces, etc.

Also shown in FIG. 1A are axes of a Cartesian coordinate system depicted as if positioned at the center of gravity of device 100. In the illustrated embodiment, device 100 is substantially a hexahedron, with opposing sides having equal dimensions but not all sides having equal dimensions (although it may be a true cube in some implementations).

Therefore, the x-axis of the device is collinear with an imaginary line bisecting the device's center of gravity and orthogonal to the left and right edges; positive values on the x-axis are along the ray that penetrates right edge 106. The y-axis is collinear with an imaginary line bisecting the center of gravity and orthogonal to the head and tail; positive values on the y-axis are along the ray that penetrates top 104. The z-axis of the device is collinear with an imaginary line bisecting the center of gravity and orthogonal to the obverse and reverse; positive values on the z-axis are along the ray that penetrates obverse 102. Regardless of the device's orientation, these axes remain fixed, and may be used to describe the application of force(s) to the device (e.g., gravity, acceleration) and the creation of a gravity-based password.

FIG. 1B is a block diagram of the device at rest, according to some embodiments of the invention. Device 100 is in a neutral position, facing upward, with obverse 102, reverse 112 and the device's x and y axes parallel to the surface of the earth. Acceleration vector 120 demonstrates the force of acceleration applied to the device at rest. Specifically, the force of gravity is aligned with the z-axis, with a magnitude of 9.8 m/sec² applied along the z-axis.

Because acceleration is applied only along the z-axis, the x-axis and y-axis components of the gravity vector are equal to each other and to 0. In embodiments of the invention described herein, data output by the device's gravity sensor and depicted by acceleration vector 120 are represented as three-dimensional values in the form (x-component, y-component, z-component). Thus, data associated with the state of device 100 in FIG. 1B may be represented as (0, 0, 9.8). If other units of measurement are employed (i.e., instead of m/sec²), the values may change accordingly.

In some implementations of the invention, the acceleration force and vector may alternatively be characterized as a gravity force and gravity vector. In such an implementation, the force exhibited in FIG. 1B may be measured as −9.8 m/sec², representing the force of gravity, having a single component along the negative z-axis (in the opposite direction of the acceleration depicted in FIG. 1B). Regardless of how the force is characterized and measured, data representing the force (e.g., from an accelerometer and/or other components) is used to create and test a password as described herein.

As the device is manipulated so that it is no longer in the “resting” position shown in FIG. 1B, data output by the gravity sensor will reflect the changing orientation of the device.

FIGS. 2A-B are block diagrams depicting device 100 after it has been manipulated out of the neutral resting position demonstrated in FIGS. 1A-B.

In FIG. 2A, device 100 has been manipulated such that the y-axis of the device remains parallel to or even collinear with the y-axis of the device at rest in FIG. 1B, and therefore acceleration vector 220a has a y-axis component of 0. The x-axis and z-axis components of the acceleration vector have changed, however, because the x-z plane of the device has shifted. The angle between the device's current x-axis and the “at rest” x-axis (as shown in FIG. 1A, for example) is approximately 60°. This means that the current z-axis is approximately 30° from being parallel with the surface of the earth. Acceleration vector 220a reflects, the force of acceleration reported by the device's gravity sensor, and is equal or approximately equal to (8.0, 5.66, 0).

In FIG. 2B, device 100 has transitioned to a position in which the plane defined by the device's y and z axes is parallel to the surface of the earth. The full magnitude of acceleration vector 220b is therefore along the x-axis, yielding a data value of (9.8, 0, 0). In embodiments of the invention, as device 100 is further manipulated, its gravity sensor continues to report three-dimensional data values reflecting the force of acceleration detected by the sensor.

To create a password (also known as a target or model pattern of manipulation), a user of a device first initiates an application or utility program designed to store a gravity-based password. For example, the user may execute, on the device, a program designed to capture gravity sensor data as the user exhibits the desired pattern of manipulation. After activating the program, or a control (e.g., icon, button) for initiating data recording, he flips, moves, rotates or otherwise manipulates the device in two or three dimensions. He may then finish the pattern by terminating the program or activating the same or a different control to terminate the recording of data. As described further below, data reported by the sensor is used as, or to generate, elements of the password.

Alternatively, some other action (or inaction) may terminate the process of storing a password. For example, data recording may automatically stop after some threshold period of time with no or minimal movement of the device (e.g., minimal change in the acceleration vector). Thus, if the user wishes to store as a password a pattern of manipulation that ends with the device having an orientation in which it is difficult to manipulate the necessary control for terminating data recording (e.g., with a touch-sensitive screen facing downward), such recording may cease automatically.

In other implementations, recording may stop automatically after a set period of time (e.g., five seconds), after a predetermined or sufficient amount of data is captured, after a particular sequence of manipulation is performed that signals an end to recording, etc. A control for terminating (or commencing) creation of a gravity-based password may be verbal or audio-based. The device may vibrate or make some other alert to signal a user that creation of a password has commenced and/or that a new password has been recorded or entered.

In some embodiments of the invention, a minimal amount of manipulation may be required for as a password, and the user may be advised if her attempted password creation failed (or, conversely, if it was successful). The user may be required to verify the desired password one or more times after successfully entering it a first time, before it will be accepted and stored as the device's gravity-based password.

Data representing the gravity-based password may be stored as-is (e.g., as generated by the gravity sensor or received by a device processor), may be hashed, may be encrypted, may be compressed and/or may be processed in some other manner before or after being stored. For example, data representing the password may be augmented to provide a margin of error to be applied when a user re-enters the password (e.g., to unlock the device). Because the user may be unlikely to re-enter a gravity-based password exactly the same as it was stored, incorporating variance into the stored password allows for some error when the user attempts to unlock the device. Alternatively, variance may be applied to data generated when the user attempts to re-enter the password to unlock the device and/or the password attempt is compared to the stored password.

In some embodiments of the invention, a gravity-based password identifies a sequence of edges or surfaces of the device that host the largest component of the gravity (or acceleration) vector, as the device is moved or manipulated. In these embodiments, as the device is manipulated and different surfaces carry all or the greatest portion of the acceleration or gravity vector (e.g., obverse, reverse, head, tail, right edge, left edge), the password is assembled from that sequence of surfaces. The surface that carries the greatest portion of the gravity vector will be the surface closest to facing directly downward toward the center of gravity of the earth.

For example, starting from the “at rest” position of FIG. 1B, if device 100 were rotated about the y-axis, as shown in FIGS. 2A-B, and such rotation continued until the device once again was in the “at rest” position of FIG. 1B, the sequence of surfaces would be: reverse 112, left edge 116, obverse 102, right edge 106 and reverse 112. Thus, the password would comprise data identifying those surfaces, in the same order. If the device were locked with that password, the user would have to manipulate the device so as to repeat the same sequence of surfaces. A gravity-based password consisting of a sequence of device surfaces may be stored as a string (e.g., a concatenation of identities of the sides), an ordered sequence of integers identifying the surfaces, or as some other sort of data.

In these embodiments that use a sequence of device surfaces as a gravity-based password, it may not matter how slowly or how quickly the device is flipped from one surface to another; simply the sequence of surfaces having the greatest components of gravity would be stored, regardless of how long it took to transition from one surface to another. A time-out period, however, may apply to limit the duration of a password or an attempt to enter a password.

Alternatively, in some implementations, however, the speed of manipulation may matter. For example, as the device is manipulated to create a new password, it may issue an audible alert (or other type of alert) when a new surface is added to the password sequence. If the user delays too long in changing the orientation of the device to cause a different surface to face downward more than the previous surface, the same surface may be added to the password sequence again (and another alert issued).

Also, in these embodiments, a surface need not be orthogonal to the force of gravity in order to form the new data point. For example, as device 100 transitioned from the at-rest orientation of FIG. 1B toward the orientation of FIG. 2A, as soon as the angle between the current x-axis of the device and the “at rest” x-axis exceeded 45°, left edge 116 became the new data point in place of reverse 112 and was added as the second element of the password.

This is illustrated in FIGS. 3A-B, which demonstrate manipulation of a device to create or to enter a gravity-based password consisting of a specific sequence of surfaces or sides of the device. This type of password may be termed a “surface sequence” password.

In FIG. 3A, device 300 is being manipulated to enter a surface-sequence password. Entry of the password may have just commenced, meaning that the next change in orientation of the device sufficient enough to place a surface other than tail 314 as the most downward-facing surface will make that surface the first element of the password, or tail 314 may be the most recent (or the first) surface in the sequence of surfaces, and the next surface to become more downward-facing than tail 314 will become the next element in the surface sequence password.

As shown in FIG. 3A, the x and z axes of the device are parallel to the surface of the earth, and the y-axis is perpendicular to the surface and therefore coincident with the force of gravity. The full component of gravity vector 320a is therefore along the negative y-axis.

In FIG. 3B, device 300 has been tilted such that its x-axis is still perpendicular to the force of gravity, but, because the y-axis and the z-axis are now both tilted at 45° angles to the earth's surface, the gravity vector has equal components in the negative y and negative z axes. Once the tilt increases slightly, the surface of reverse 312 of device 300 will be more downward-facing than any other surface, and a new element will be added to the password. Thus, in these embodiments of the invention, as device 300 is flipped, waved or otherwise manipulated so that a sequence of different surfaces bear the majority of the force of gravity, that sequence is concatenated as a gravity-based surface sequence password—either for storage as a new password or for comparison with a stored password (e.g., to unlock the device for use).

It may be noted that instead of focusing on the surface that is most downward-facing, in other implementations the focus of a surface sequence password may focus on the most upward-facing surface, the most leftward-facing surface, etc.

In other embodiments of the invention, instead of being a sequence of surfaces, a gravity-based password may be derived from a series of data points arising from three-dimensional movement of a device, and may be termed a “free motion” gravity-based password. In these embodiments, a user may create/enter a free-motion password by waving the device in the air, tossing it, bumping it, etc. Acceleration reported by the device's gravity sensor(s) represents the force of acceleration applied to the device, again in three dimensions.

Each data point reported by the gravity sensor in these embodiments of the invention may be captured in sequence as they are output by the sensor according to its reporting or duty cycle (e.g., every 1 ms, every 10 ms), and may continue until the password is complete, until the entry process times out, until the user or device aborts the process, etc. Data generated by an attempt to enter a password to unlock a locked device will be compared to the stored password. If they match, within some degree of tolerance for variance, the device will be unlocked.

The points of data used to create a free-motion password may comprise values for an acceleration vector (e.g., reported by an accelerometer), a gravity vector, a location or something else. In general, data reported by one or more sensors as the device is moved is collected in sequence and used as the password or as a basis for deriving the password.

For example, if the data values are produced by a triple axis accelerometer, the data values may be three-dimensional values that change with the acceleration experienced by the device as a user manipulates it. A sequence of those values may be saved as received from the accelerometer, may be plotted to yield a three-dimensional graph to be stored, may be augmented with some variance or error to aid a user's re-entry of the password, etc. If the accelerometer is dual-axis, the values may necessarily be two-dimensional as well.

Data reported by other sensors that detect changes in the position or in an orientation of the device, or that detect different forces applied to or experienced by the device, may also be used—such as a gyroscope to measure forces applied to a base or normal orientation, a location sensor (e.g., a GPS receiver) that can detect changes in physical location, etc.

Thus, a free-motion gravity-based password may be stored as a sequence of (two- or three-dimensional) points representing components of some force reported by a device sensor, some orientation or change in orientation of the device, actual spatial coordinates or something else, depending on whether the sensor that produces the data is an accelerometer, a gyroscope, a position/location sensor, etc.

In some embodiments of the invention, a free-motion password generated from data produced by an accelerometer may be considered to be a form of acceleration-based access control, in addition to or instead of gravity-based.

FIGS. 4A-C are graphs of data representing a free-motion acceleration-based password, or data from which such a password may be derived, according to some embodiments of the invention. Although the graph is only two-dimensional, embodiments of the invention in which three-dimensional data are employed may be readily derived from the figures and the accompanying description.

In some implementations of an embodiment of the invention depicted in FIGS. 4A-C, a dual-axis accelerometer or other device sensor outputs two-dimensional data values, which may be represented as (x-component, y-component) for purposes of plotting. Specifically, the points plotted in these graphs represent the data output by the accelerometer as a user manipulated the device in a pattern she desires to use as her acceleration-based free-motion password, or in a pattern intended to recreate her stored password (e.g., in order to unlock it).

Points 402a-402h of graph 400 are eight points plotted in the order received from the accelerometer. For example, initial point 402a represents the first data point output by the accelerometer after the user began entering the password, and demonstrates acceleration of the device primarily along the negative x-axis, but also with a component in the negative y-axis. Second point 402b reflects a change in the acceleration in the direction of the positive y-axis, but still primarily along the negative x-axis. Points 402c-402g represent additional acceleration data until the password ends with point 402h, which represents no acceleration in the x-y plane (e.g., the device is at rest on its front or back surface, the device is in free-fall).

In embodiments of the invention, a gravity-based password may, but need not, start and/or end with the device at rest. Any number of data points or data sets may be captured as the device is manipulated. The frequency or rate at which data are produced (e.g., by an accelerometer), received (e.g., by a processor) or stored (e.g., in memory) may depend upon the sensor's design, the application or utility software that is implementing the password, and/or other factors.

For example, the accelerometer or other sensor may output data every 0.5 ms, every 2 ms or with some other frequency, as long as the device (or the sensor) is turned on. The application, or a processor executing the application, may accept (and use) every data value, every other data value, or some other subset of all data output by the sensor.

For example, in some implementations, instead of using every data value received from the sensor, the application may attempt to sample data with a predetermined periodicity. For example, it may be designed to capture, record and/or save the current sensor data every 4 ms, and ignore values received between sampling times. Or, it may average multiple data values received during a sampling period, and only record and use the average.

References herein to using sensor data to derive a password should be understood to encompass use of all or a subset of the data received from the sensor. The data will generally be used/applied in order, as actual individual elements of the password, as input to computing average values to form elements of the password, or to be processed in some other fashion to construct the password. Thus, sensor data (e.g., two- or three-dimensional points) may be used as-is as elements of a free-motion acceleration-based password, or may be processed in some way to produce elements of the password.

Returning to FIG. 4A, the illustrated data points may therefore be saved and/or used as they are—a sequence of eight points mapped to two-dimensional space. It may be noted that as long as the data is or can be represented as two- (or three-) dimensional data, it can be graphed and used as (or to generate) a password, regardless of what type of data it is (e.g., acceleration, gravity, torque, velocity).

As shown in graph 420 of FIG. 4B, however, the data points may instead be saved and/or used with corresponding variances or deltas, represented by the circles about each data point. When a current password entry attempt is compared to a saved password, variance may be applied to either or both sequences of data, thereby allowing a user to unlock her device with a pattern of movement that does not match the stored password exactly, but yet matches closely enough to make it unlikely that she is someone trying to guess the correct password.

In an embodiment of the invention reflected in FIG. 4B, when a current password is compared to a stored password, comparison may begin with a first current point of data of the accelerometer (or other sensor) that is received after a user activates a control to signify that he is commencing password entry. Alternatively, in case the user pauses after activating the control, for a period of time greater than or less than he paused when recording the stored or model password, the application may begin the comparison with a first point of data that matches (or that is sufficiently similar) to the first point of the stored password (e.g., point 402a). This means that one or more preceding data points may be ignored.

As another alternative for matching a password entry attempt with a stored password, after the user completes the current password entry attempt, the application may attempt to match the current sequence of data points with the stored sequence. With margins of error around either of both sequences of points, the current password attempt may match without being exactly the same. For aid in aligning a current password attempt with a stored password, a first N number of sensor data points (N≧1) of the current attempt and/or the stored password may have greater variance than other points.

In other implementations, and as shown in FIG. 4C, a set of data points may be used to plot a curve representing the password, with or without variance or margins of error. In these implementations, some sort of analysis may be performed between curve 410 (if it is the stored password) and a current curve plotted from an attempt to re-enter the password, or between curve 410 (if it is a password re-entry attempt) and a stored password.

For example, after collecting data points 402, linear interpolation could be applied to “fill-in” between data points to provide a smoother curve. This may be more useful if the data points are sparse, which may occur if only 1 of every X (X>1) data values reported by the gravity sensor are used. Then, the distance between the curves of the stored password and the current password entry attempt could be compared to determine if they are sufficiently close. One or more versions of the stored password could be saved (e.g., a set of points, a set of points with predetermined permitted variance, a graph of data points, a smoothed (e.g., interpolated) curve, a curve with variance), to facilitate later comparison with a user's attempt to re-enter the password (e.g., to unlock the device).

Some methods of testing for correlation or covariance between two sets of points are known, such as Pearson's correlation (or the Pearson product-moment correlation coefficient). Thus, armed with a first set of data values representing a stored free-motion gravity-based password, a second set of data values derived from a current attempt to enter that password may be compared to the first set to determine if they are sufficiently similar.

Yet further, in some embodiments of the invention “noise” in the form of spurious error in the pattern of manipulation of a device may be reduced. For example, if the data set of a free-motion gravity-based password is fairly dense (e.g., consists of frequent data points from a sensor), median filtering may be applied to replace some number of elements (data points) with the median of neighboring elements.

In some embodiments, when creating a new free-motion password, a user may be required to perform the desired pattern multiple times. Data sets for one or more repetitions may be eliminated (e.g., if they vary significantly from the others), some or all data sets may be averaged to produce an average pattern or to help determine the appropriate variance to apply to comparison between the stored password and an attempt to recreate or re-enter that password, etc.

When variance or a margin of error is applied to a data point (or a set of data points), it may be proportional to the motion of the device. For example, the faster (or more forcefully) a password pattern is entered, the more variance may be permitted. Further, a “shape” of variance may vary. For example, the variance permitted in an embodiment of the invention represented in FIG. 4B is depicted as circular—equidistant in all directions from a given data point. In some implementations, the permitted variation may be greater in the direction(s) parallel at that point to a curve of the data set. If such dynamic variance were applied to points graph 440 of FIG. 4C, for example, the variance may be plotted as ellipses around the points, with the major axes of the ellipses being parallel to the curve, and possibly with a dimension proportional to the magnitude of the force represented by the data point.

FIGS. 5A-B are a flow chart demonstrating entry of a gravity-based password, according to some embodiments of the invention. The illustrated method may be performed by a device comprising one or more sensors (e.g., accelerometer, gyroscope), or by a system or other entity coupled to the device and capable of receiving sensor data from the device.

In operation 502, an application or utility program for using or accepting a gravity-based password receives a command, from a user, to initiate acceptance of a password. The command may comprise activation of an application icon, pressing of a key or other control, speaking a verbal command, orienting the device in particular manner (e.g., face-up), etc.

In different implementations, the illustrated method may be applied to create and store a new password, or may be applied to receive a password entry when the user attempts to recreate the stored password. Thus, prior to or as part of operation 502, the application or device may receive other input, such as activation of software code for recording a gravity-based password, activation of a control or motion of the device causing a display screen of the device to light, activation of a control for waking-up the device, etc.

In optional operation 504, the device (or application) confirms the command by vibrating, chirping, blinking or making some other audible, visual or physical alert. In some embodiments, after activation of the command in operation 502, the user may re-orient the device into a starting position before entry of the password commences. In these embodiments, operation 504 signals the user that he or she can or should begin the password. Alternatively, operation 504 may be separate from any alert to signal commencement of password entry.

In operation 506, the user manipulates the device in some way, whether by waving it through the air, tossing it, flipping it, rotating it, etc. As described previously, the password may be derived from an ordered sequence of sides of the device, or from an ordered sequence of points of data produced by a device sensor. The movement of the device by the user may reflect the nature of the password pattern. Thus, the user may simply flip the device over different edges in a particular sequence, or alternatively may move it freely about three-dimensional space.

As described above, entry of a “surface sequence” gravity password captures the sequence of surfaces of the device as it is flipped on its edges; movement of the device within two or three dimensions is irrelevant except to the extent it involves changing the orientation of the device such that a different surface faces more downward than any other surface. In contrast, a “free-motion” gravity password captures data output by one or more sensors as the device moves through two- or three-dimensional space; flipping of the device from one surface to another is irrelevant except to the extent it involves changing the data that is output by the active sensor(s).

In operation 508, one or more elements of the password, or data for generating one or more password elements, are captured and may be recorded (e.g., stored in memory). In these embodiments, an element of a gravity-based password may be a surface of the device or information identifying a device surface (in the case of a surface sequence password), or may include one or more data points output by an accelerometer or other sensor (in the case of a free-motion password). As discussed earlier, data points may be constantly or regularly output by the sensor, and some or all of them may be captured as elements of the password or may be used to derive elements of the password.

Audible, visible and/or physical alerts may be generated by the device while the device is manipulated. For example, if the user is entering a new password, the device may generate an alert each time a different surface is added to the password (for a surface sequence password), or each time it captures a data point during free movement of the device (or after some number of data points are captured).

In operation 510, the password application or utility (or other component of the device) determines whether entry of the password has completed or been terminated. If the password was being entered to be stored as the new password, it may terminate when the user specifies it is complete by inputting a command or activating a control (e.g., any key, button, switch or other physical control on the device), may terminate after some period of time, etc.

If the password is being entered to unlock the device or is to be compared with a stored password for some other reason, password entry may terminate when the manipulation pattern has been recreated (thereby unlocking the device if it was locked), when a maximum period of time has elapsed (e.g., with or without matching the stored password), when the user activates a control or manipulates the device in a special way to signify cancellation of password entry, etc.

If password entry has not yet completed, the method returns to operation 506 and the device is further manipulated and one or more additional elements of the password are captured. If password entry has completed, the method advances to operation 512.

In operation 512, it is determined whether the password is accepted. In this context, “accepted” simply means that sufficient data of a suitable type has been captured to use as a password or to compare with a stored password. Illustratively, there may be a minimum number of elements for a password, that is, a minimum number of device surfaces or sensor data points that must be captured. If the user is entering a new password, operation 512 may entail determining whether the user has manipulated the device sufficiently and in an appropriate manner to be used as a password.

A password entry may not be accepted if the user issues a command or takes action to cancel the password entry, if she aborts the entry process, if there is an interruption in data from the sensor, if the device becomes busy with some other task (e.g., receives a telephone call) and/or for other reasons.

If the password is accepted, the method advances to operation 514; otherwise, it returns to operation 502 or operation 506 to restart or to resume password entry.

In operation 514, further processing depends upon the purpose for the password entry. If the password is being entered as a new password, the method advances to operation 520; if the password is being entered to be compared with a stored password (e.g., to unlock the device), the method advances to operation 540.

In operation 520, data captured during the user's manipulation of the device in accordance with his desired pattern is processed. Processing of the sensor data may differ depending on the type of password the user has chosen.

Illustratively, if he chose to create a surface sequence type of gravity-based password (e.g., when he activated the software for collecting the password), processing may entail filtering out unnecessary data, replacing data values with identifiers of device surfaces, noting the period of time that a surface was the most downward-facing surface, etc. For example, if the gravity sensor repeatedly reported the device's status (e.g., as data indicating which axis or surface of the device bore the largest component of the gravity vector), regardless of whether a new surface has become the most downward-facing surface, operation 520 may include condensing the data to an ordered sequence of changes in surfaces. This may require translation between numerical values reported by the sensor to other values for identifying device surfaces (e.g., strings), eliminating multiple data points reporting the same device status (i.e., the same surface facing downward), etc.

If the user chose to create a free-motion password, processing may entail plotting some or all data points received from the gravity sensor(s), interpolating a curve of graphed points, calculating a permitted variance, dropping one or more points, converting the data values (e.g., from floating point to integer), rounding/truncating one or more values, etc.

In operation 522, the password application or utility prompts the user to repeat the password pattern one or more times. Illustratively, the more intricate the pattern (e.g., especially for a free-motion gravity-based password), the more repetitions may be required. The length of a pattern, the amount of data collected during the pattern, the magnitude of deltas between adjacent data points and/or other factors may affect the intricacy of the pattern. A surface sequence password involving four changes in surfaces will be less intricate than a free-motion password lasting five seconds, for example.

In operation 524, the final password is created, possibly by changing the elements derived in operation 520 based on the pattern repetitions of operation 522. The final password may not differ from the sequence obtained in operation 520 if, for example, it is a surface sequence password that is relatively simple and the user repeated the same sequence in operation 522.

Conversely, however, the final password may differ from the pattern processed in operation 520. For example, in the case of a free-motion password, the final pattern may be an average of any or all of the patterns obtain before and during operation 522, may be the same as that derived in operation 520, but with a variance profile derived from the pattern repetitions of operation 522, or may exhibit some other combination of the original pattern and the repeated patters of operation 522.

Finally, in operation 526 the password is stored. If it is a surface sequence password, it may be stored as a collection of strings, integers or other values representing or identifying device surfaces. If it is a free-motion password, it may be stored as multi-dimensional points, an ordered sequence of data points, an ordered sequence of the components of data points (e.g., the x-, y- and z-components), a matrix of data values, etc.

In different implementations, stored passwords may be of different data types, such as numerical (e.g., integer, floating-point) or string. A new password may be hashed (e.g., with MD5 or SH1) and/or encrypted (one-way or reversible) before being stored.

After operation 526, the illustrated method ends.

In operation 540, the user has completed an attempt to re-enter a stored password to unlock the device or otherwise make it (or some associated entity) usable. Now, elements of the current pattern are processed as necessary. The processing of operation 540 may be similar to processing described in conjunction with operation 520.

Illustratively, if the device is currently secured with a surface sequence type of gravity-based password, processing may entail converting the data generated during the pattern entry into a suitable form or format for comparison with the stored password. This may require numerical values be converted into strings, elimination of repetitious values, etc.

If the stored password is a free-motion password, the processing may include formatting or converting the data values obtained during entry of the pattern, calculation or application of appropriate variance, etc.

In operation 542, the current attempted password is compared with the stored password. This may require retrieval of the stored password, encryption of the new password elements (or decryption of elements of the stored password), hashing the new password (if the stored password was hashed), analysis of current and stored data sets, analysis of graphed data sets, etc.

If the passwords are free-motion, comparing them may involve comparing each element or each point of the password in order, with the same or different variance applied to each pair of elements or points. Applying variance may involve adding some margin of error to some or all elements or points. Illustratively, for a three-dimensional gravity password, variance may be defined in each axis (i.e., +x, −x, +y, −y, +z, −z).

In operation 544, if the current and stored passwords match, within any allowable variance, the device is unlocked in operation 546 and the method ends. If they do not match, the method may still end (without unlocking the device) or may return to operation 502 or some other operation.

In embodiments of the invention, a gravity-based password is designed by a user; it is not predetermined by a manufacturer of the device. Because it may be difficult for one user to replicate another user pattern of manipulation, even if that manipulation can be viewed, it may be necessary for each user to enter his or her own password, and to be the one to recreate it when the device is to be unlocked.

In some embodiments of the invention, multiple gravity-based passwords may be stored for a user, and she only needs to recreate one of them to unlock her device. The multiple passwords may be of the same type or different types (e.g., a surface sequence password and a free-motion password). Also, a regular security code, password or other method of access control may be used as a backup or in case the user is unable to recreate her gravity-based password.

In some embodiments of the invention, while entering a password, whether for storage as her new password or to unlock her device, a particular motion or movement of the device may signal cancellation (and possibly restarting) of the password entry attempt, completion of the pattern, correction to a just completed action, etc. For example, while entering a surface sequence password, if the user realizes she made an error, she could make the special movement to stop and restart the attempt, to cancel the last two surface changes (e.g., if she undid the incorrect surface transition before making the special movement), etc.

The special movement or motion may entail different things in different implementations. For example, with a surface sequence password, the motion could be rotation of the device within its current plane. Thus, if it is currently in the at-rest position of FIG. 1B, rotating it about the z axis, possibly some degrees in one direction (e.g., counterclockwise) and then back, may complete the movement. If the password is a free-motion password, possibly tapping a particular corner of the device a specified number of times (e.g., twice) against a hard object with a minimum (or maximum) force may complete the movement.

FIG. 6 is a block diagram of an apparatus compatible with a gravity-based access control scheme, according to some embodiments of the invention. Apparatus 600 of FIG. 6 includes one or more processors 602, memory 604, accelerometer 610, gyroscope 612, position sensor(s) 614 and gravity-based access control logic 620.

Apparatus 600 may include other components not depicted in FIG. 6, such as a power source (e.g., a battery, an alternating current port), display screen, controls for operating the apparatus, an antenna, communication modules, etc. In other embodiments, an apparatus for implementing gravity-based access control may include a different array of components (e.g., more or fewer sensors), other logic (e.g., for completing telephone calls, for managing contacts), etc.

Processors 602 are configured to execute logic loaded into memory 604, receive data from sensors 610, 612, 614, control operation of the apparatus for its specified purpose (e.g., as a telephone, as a computer, as a graphics display device), etc. Memory 604 is solid-state memory configured to store logic for execution by a processor, and data for storage and/or manipulation by a processor.

Accelerometer 610 measures an acceleration force applied to apparatus 600, and is preferably a two- or three-axis accelerometer, but may be a single-axis accelerometer in some limited embodiments of the invention. Accelerometer 610 measures dynamic acceleration (e.g., vibration) and/or static acceleration (e.g., gravity), and may also be able to measure position, motion, tilt and/or shock. In different implementations, the accelerometer may have different sensitivities (e.g., 2 microgravities), different ranges (e.g., −3 gravities to 3 gravities), different duty cycles (e.g., 0.5 ms, 5 ms, 10 ms) and/or other differing attributes. It may be a MEMS (MicroElectroMechanical System) device, may be of piezoelectric, piezoresistive, capacitive or some other design.

Gyroscope 612 measures the orientation of apparatus 600. It may be a MEMS device, may be a vibrating structure gyroscope (VSG) or may be of some other design.

Position sensor 614 may be a GPS receiver or some other sensor that can detect or facilitate identification of a position of apparatus 600, possibly relative to another entity emitting an electromagnetic field or beam.

Gravity-based access control logic 620 comprises processor-executable instructions for obtaining and/or using a gravity-based password as described above. Apparatus 620 may include other related logic, for operating a sensor, for processing data received from a sensor, for manipulating a password (e.g., to compare a stored password with a current password entry attempt), etc.

Embodiments of the invention have been described for implementing a gravity-based method of access control. If a current pattern of movement of a device sufficiently matches a password, a lock on or associated with that device (or associated with some entity coupled to the device) is disengaged. The manner in which the password and/or current pattern of movement are described, plotted, saved, compared or otherwise processed may vary from one implementation to another.

Thus, references to passwords (e.g., stored passwords, attempts to enter a password), patterns of movements and data representing passwords and/or patterns of movement may be understood to refer to a sequence of movement of a device, to data generated by one or more device sensors during such movement, to representations of that data or the movement, to adjusted data or adjusted representations (e.g., to incorporate variance, to change the form or format of the data) and so on.

The environment in which some embodiments of the invention are executed may incorporate a general-purpose computer or a special-purpose device such as a hand-held computer or communication device. Details of such devices (e.g., processor, memory, data storage, display) may be omitted for the sake of clarity.

Data structures and code described in this detailed description are typically stored on a non-transitory computer-readable storage medium, which may be any device or medium that can store code and/or data for use by a computer system. Non-transitory computer-readable storage media includes, but is not limited to, volatile memory, non-volatile memory, magnetic and optical storage devices such as disk drives, magnetic tape, CDs (compact discs), DVDs (digital versatile discs or digital video discs), or other non-transitory computer-readable media now known or later developed.

The methods and processes described in the detailed description can be embodied as code and/or data, which can be stored in a non-transitory computer-readable storage medium as described above. When a processor or computer system reads and executes the code and/or data stored on the medium, the processor or computer system performs the methods and processes embodied as data structures and code and stored within the medium.

Furthermore, the methods and processes described below can be included in hardware modules. For example, the hardware modules may include, but are not limited to, application-specific integrated circuit (ASIC) chips, field-programmable gate arrays (FPGAs) and other programmable-logic devices now known or later developed. When the hardware modules are activated, the hardware modules perform the methods and processes included within the hardware modules.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

What is claimed is:

1. An apparatus, comprising:
a gravity sensor;
a processor configured to:
receive from the gravity sensor a current sequence of data identifying a current pattern of movement of the apparatus;
compare the current sequence of data to a model sequence of data identifying a model pattern of movement of the apparatus; and
unlock the apparatus if the current sequence of data matches the model sequence of data; and
a memory.

2. The apparatus of claim 1, wherein the processor is further configured to, prior to receiving the current sequence of data:
receive from the gravity sensor the model sequence of data as the apparatus is moved according to the model pattern; and
store a representation of the model sequence of data.

3. The apparatus of claim 2, wherein:
the stored representation of the model sequence of data comprises the model sequence of data and a variance; and
the variance allows the current sequence of data to match the model sequence of data if they differ within a margin of error defined by the variance.

4. The apparatus of claim 1, wherein comparing the current sequence of data to a model sequence of data comprises:
adjusting the current sequence of data to allow for variance between the model pattern and the current pattern; and
comparing the adjusted current sequence of data to the model sequence of data.

5. The apparatus of claim 1, wherein comparing the current sequence of data to a model sequence of data comprises:
adjusting the model sequence of data to allow for variance between the model pattern and the current pattern; and
comparing the adjusted model sequence of data to the current sequence of data.

6. The apparatus of claim 1, wherein:
the current pattern of movement and the model pattern of movement comprise movement of the apparatus in three dimensions.

7. The apparatus of claim 6, wherein the processor is further configured to:
graph one or more of the current sequence of data and the model sequence of data.

8. The apparatus of claim 1, wherein:
the current pattern of movement and the model pattern of movement comprise sequences of movements of the apparatus that cause different surfaces of the apparatus to be more downward-facing than all other surfaces.

9. A method of controlling access to a device, comprising:
receiving, at a processor, a current series of data describing a current pattern of multi-dimensional movement of the device;
comparing, with the processor, the current series of data and a model series of data describing a model pattern of movement of the device; and
disengaging a lock if the received series of data matches the model series of data.

10. The method of claim 9, further comprising, prior to receiving the current series of data:
receiving, at the processor, the model series of data as the device is moved according to the model pattern of movement.

11. The method of claim 9, wherein the received series of data matches the model series of data if they differ by no more than a variance associated with either or both of the received series of data and the model series of data.

12. The method of claim 9, wherein disengaging a lock comprises unlocking the device.

13. The method of claim 9, wherein disengaging a lock comprises unlocking an electronic system coupled to the device.

14. The method of claim 9, wherein receiving the current series of data comprises:
during the current pattern of movement, receiving data identifying which one of multiple surfaces of the device is currently facing in a predetermined direction more than any other surface.

15. The method of claim 14, wherein receiving the current series of data further comprises:
each time a different surface of the device is identified as facing the predetermined direction more than any other surface, including that different surface as part of the current series of data.

16. The method of claim 9, wherein receiving the current series of data comprises:
during the current pattern of movement, receiving multi-dimensional sensor data.

17. The method of claim 16, wherein the multi-dimensional sensor data includes data received from an accelerometer.

18. The method of claim 16, wherein the multi-dimensional sensor data includes data received from a gyroscope.

19. The method of claim 16, wherein the multi-dimensional sensor data includes data received from a position sensor.

20. A non-transitory computer-readable medium storing instructions that, when executed by a processor, cause the processor to perform a method of controlling access to a device, the method comprising:
receiving, at a processor, a current series of data describing a current pattern of multi-dimensional movement of the device;
comparing, with the processor, the current series of data and a model series of data describing a model pattern of movement of the device; and
if the received series of data matches the model series of data, unlocking the device.
